(19) United States
(12) Patent Application Publication
(10) Pub. No.: US 2007/0152127 A1
(43) Pub. Date: Jul. 5, 2007

(54) Portable device securing mechanism

(75) Inventor: Guang-Yi Kao, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/394,972

(22) Filed: Mar. 30, 2006

(30) Foreign Application Priority Data
Dec. 29, 2005 (TW) 94222948

(51) Int. Cl. F16M 3/00

(52) U.S. Cl. 248/681

(57) ABSTRACT

A portable device securing mechanism for securing a portable device in a compartment of an electronic device includes first and second openings formed in the compartment to fit the portable device in the compartment. A first surface of the portable device is exposed through the first opening. Stop members and a first snap-fit member are disposed on a bottom surface of the compartment. The stop members press against a second surface of the portable device to limit displacement of the portable device toward the second opening, wherein the second surface is opposite to the first surface. Disposed on the second surface is an elastic element on which a second snap-fit member is disposed for engagement with the first snap-fit member. Given the snap-fit engagement of the first and second snap-fit members, the portable device is fixed in the compartment, and thus the portable device may be swiftly uninstalled or installed.

### BACKGROUND OF THE INVENTION

1. Field of the Invention

The present invention relates to a portable device securing mechanism, and more particularly, to a securing mechanism for securing a portable device in a compartment of an electronic device.

2. Description of Related Art

Portable devices have been widely used in electronic devices, such as servers and personal computers, and come in a variety of types. Hence, to be inserted into compatible compartments, portable devices nowadays are standardized in terms of dimensions.

Nevertheless, a portable device has to be disposed at a spare location, whenever the portable device is adopted impromptu and thereby does not come in standard size, or in a situation where, with all its compartments being occupied, the electronic device cannot take any more components.

Referring to FIG. 1, wherein a portable device, for example, a LED indicator 10, is fixed in a heat dissipating channel 12 of a server 1. The indicator 10 is provided with an indication panel 101 and tapped holes 102. An upper casing lid 11 of the server 1 is provided with corresponding installation holes 111, such that the installation holes 111 and the tapped holes 102 are locked together by means of screws 9. The upper casing lid 11, to which the indicator 10 is secured, is then secured to a casing of the server 1. As a result, the indicator 10 is fixed in the heat dissipating channel 12, and the indication panel 101 is seen on and aligned with the front of the server 1.

However, the conventional assembly method involves locking both an upper casing lid and an indicator to a server, and opening the upper casing lid fully in order to mount or dismount the indicator from the server. Hence, the assembling/dismantling process is quite complicated.

Furthermore, as regards a server, a motherboard is often changed when necessary, thus LED indicator changing is not uncommon. If locking operations are frequently performed with multiple screws, material deformation will occur especially due to unequal locking torques; given time, there may be poor tapped hole alignment.

Accordingly, an issue high on the agenda of the industry involves finding a solution to the aforesaid drawbacks of prior art.

### SUMMARY OF THE INVENTION

It is therefore an objective of the present invention to provide a portable device securing mechanism for swiftly installing/uninstalling a portable device used in an electronic device.

Another objective of the present invention is to provide a portable device securing mechanism for conveniently installing/uninstalling a portable device used in an electronic device.

Yet another objective of the present invention is to provide a portable device securing mechanism for cost reduction.

In order to achieve the above and other objectives, the present invention proposes a portable device securing mechanism for securing a portable device in an electronic device. The portable device securing mechanism comprise a compartment formed in the electronic device and provided with a first opening and a second opening, allowing the portable device to be received in the compartment and have a first surface thereof being exposed through the first opening; at least one stop member disposed on a bottom surface of the compartment, for pressing against a second surface of the portable device to limit displacement of the portable device toward the second opening, wherein the second surface is opposite to the first surface of the portable device; a first snap-fit member disposed on the bottom surface of the compartment; and an elastic element disposed on the second surface of the portable device, and formed with a second snap-fit member for being engaged with the first snap-fit member so as to allow the portable device to be secured in the compartment.

The electronic device is either a server or a personal computer. In the case of a server, the compartment is a heat dissipating channel above a hard disk compartment of the server, with the first opening functioning as an installation opening and the second opening as a ventilation opening.

The portable device is a member selected from the group consisting of a LED indicator, a disk drive holding device, a CD-ROM drive, and any other portable device. In the case of a LED indicator, the first surface thereof is a panel equipped with a plurality of LED lamps and USB slots. Also, a plurality of elastic blocks may be disposed on the surfaces of the portable device, to fill any gap between the portable device and the compartments and therefore enable a tighter grip.

Preferably, the stop members are a plurality of bumps, which are firmly attached, spaced apart and aligned, to evenly press against the second surface. The elastic element is a piece of metal; one end of the elastic element is connected to the second surface, whereas an opposite end of the elastic element extends toward the second opening. Both the first and second snap-fit members are protruding bodies which protrude and match, each having a curved, smooth slope for snap-fit engagement with each other.

The portable device further comprises an operation plate integrally connected to the elastic element. The operation plate extends toward the second opening to allow a user to unfasten the portable device from the second opening.

The fastening of the portable device entails inserting the portable device into the compartment through the first opening, with the elastic element leading the portable device into the compartment. Once the stop members stop the second surface of the portable device from proceeding, the second snap-fit member locks the first snap-fit member; snap-fit locking as such is firm and therefore may pass a throwing test. The unfastening of the portable device entails lifting the operation plate in the second opening of the compartment to unlock the first and second snap-fit members, then pushing the operation plate naturally, such that the whole portable device is moved out of the first opening and uninstalled smoothly.

In conventional technology, an upper casing lid, an indicator, and a server body lock each other, which means that uninstallation/installation of the indicator entails unscrewing/screwing a plurality of screws, thus the unlocking/locking operations are quite complicated. By contrast, with the portable device securing mechanism of the present invention, uninstallation/installation of an indicator may be achieved by taking some simple steps.

The assembly method of the present invention does not involve unscrewing or screwing any screw, thus, compared to conventional technology, the assembly method of the present invention saves users the screwing/unscrewing time.

Unlike conventional technology, the portable device securing mechanism of the present invention does not require drilling plenty of holes in a related device, thus reducing process costs.

The portable device securing mechanism of the present invention may solve various drawbacks of conventional technology and thereby has a great potential for industrial use.

### BRIEF DESCRIPTION OF DRAWINGS

The present invention can be more fully understood by reading the following detailed description of the preferred embodiments, with reference made to the accompanying drawings, wherein:

FIG. 1 is a schematic diagram showing the locking and installing of a LED indicator in a server by means of screws using conventional technology;

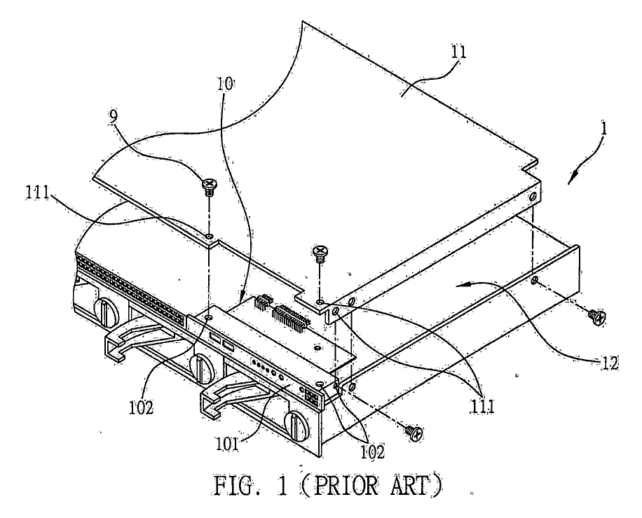

FIG. 2 is a schematic diagram showing a portable device securing mechanism according to a preferred embodiment of the present invention;

FIG. 3 is a broken-out lateral view of a portable device in which a portable device securing mechanism of the present invention is applied;

FIG. 4 is a full size oblique view of a portable device in which a portable device securing mechanism of the present invention is applied; and

FIG. 5 is a diagram showing how to finalize the securing of a portable device securing mechanism of the present invention.

### DETAILED DESCRIPTION OF PREFERRED EMBODIMENTS

The following specific embodiments are provided to illustrate the present invention. Others skilled in the art will readily understand other advantages and functions of the present invention in accordance with the contents disclosed in this specification. The present invention can also be performed or applied by other different embodiments. Various modifications and changes based on different viewpoints and applications can be made in the details of the specification without departing from the spirit of the present invention. Points needing attention are as follows: all the accompanying diagrams are simple schematic diagrams intended to schematically describe the basic structure of the present invention. Hence, in the diagrams, only those components related to the present invention are shown, and the shown components are not drawn according to their actual quantity, shape and dimensions when implemented; in practice, the specifications and dimensions of the components are selectively devised indeed, and the layout of the components may be far more intricate.

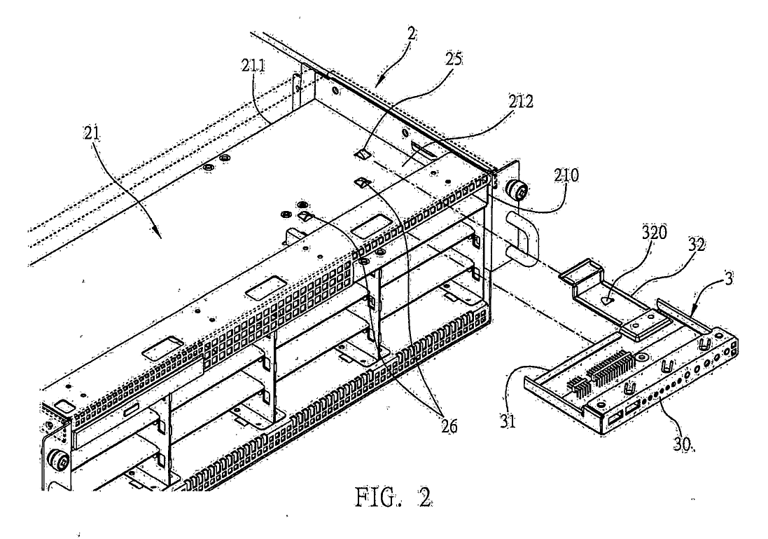

Referring to FIG. 2, which is a schematic diagram showing a portable device securing mechanism according to a preferred embodiment of the present invention.

The portable device securing mechanism of the present invention is intended to secure a portable device 3 in a compartment 21 of an electronic device 2. A first opening (installation opening) 210 is disposed on one side of the compartment 21 and a second opening (ventilation opening) 211 on an opposite side thereof, for putting the portable device 3 in the compartment 21, and exposing a first surface (panel) 30 of the portable device 3 through the first opening 210.

The electronic device 2 is either a server or a personal computer. In the case of a server, the compartment 21 is a heat dissipating channel above a hard disk compartment (not shown) of the server. The portable device 3 is a member selected from the group consisting of a LED indicator, a CD-ROM drive, a disk drive holding device, and any other portable device. In the case of a LED indicator, the first surface (panel) 30 thereof is equipped with a plurality of LED lamps and USB slots.

Stop members 26 and a first snap-fit member 25 are disposed on a bottom surface 212 of the compartment 21. The stop members 26 press against a second surface 31 of the portable device 3 to limit displacement of the portable device 3 toward the second opening 211, wherein the second surface 31 is opposite the first surface 30. The stop members 26 can be, for example, a plurality of bumps, which are firmly attached, spaced apart and aligned, to evenly press against the second surface 31 of the portable device 3.

The second surface 31 of the portable device 3 is provided with an elastic element 32 on which a second snap-fit member 320 is disposed, wherein the second snap-fit member 320 matches and locks the first snap-fit member 25, to limit outward displacement of the portable device 3 through the first opening 210 and thereby secure the portable device 3 in the compartment 21. Accordingly, with the securing mechanism, the portable device 3 may be swiftly secured in position, without using any tool.

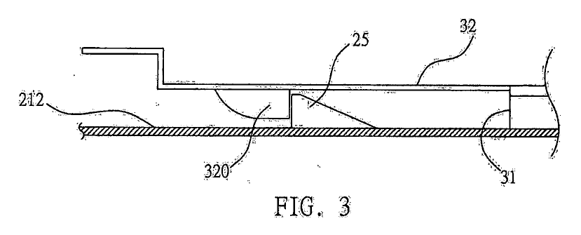

Referring to FIG. 3, the elastic element 32 is a piece of metal; one end of the elastic element 32 is connected to the second surface 31 of the portable device 3, whereas an opposite end of the elastic element 31 extends toward the second opening 211. Both the first and second snap-fit members 25, 320 are protruding bodies, matching, bulgy, and stamping-based, each having a curved, smooth slope for smooth, labor-saving, snap-fit engagement of the first and second snap-fit members.

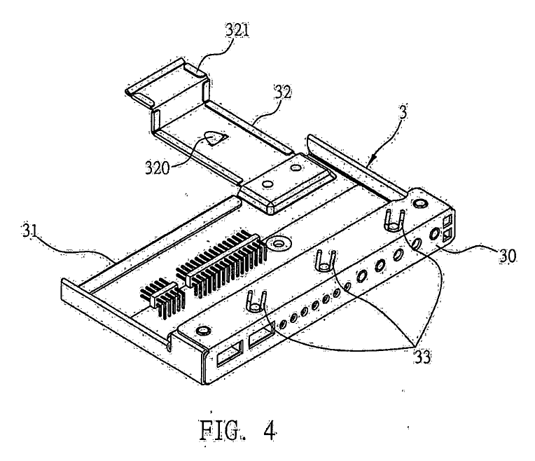

Referring to FIG. 4, a plurality of elastic blocks 33 are disposed on the top surface of the portable device 3, to fill any gap between the portable device 3 and the compartment 21, thereby fitting the portable device 3 in the compartment 21 better.

The portable device 3 further comprises an operation plate 321 integrally connected to the elastic element 32. The operation plate 321 extends toward the second opening 211 to allow a user to unfasten the portable device 3 from the second opening 211.

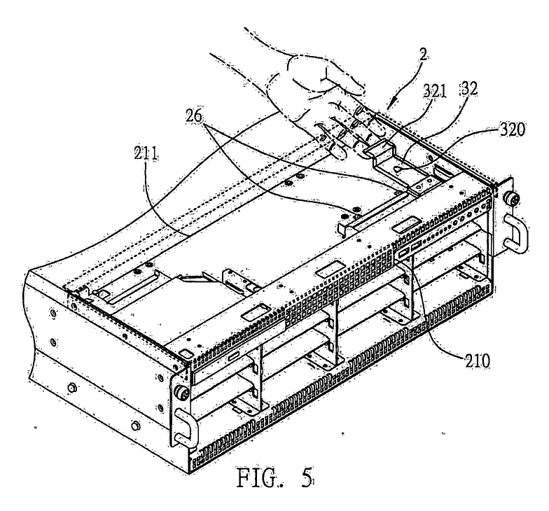

Referring to FIG. 5, the fastening of the portable device 3 entails inserting the portable device 3 into the compartment 21 through the first opening 210, with the elastic element 32 leading the portable device 3 into the compartment 21. Snap-fit locking of the first snap-fit member 25 and the second snap-fit member 320 occurs as soon as the stop members 26 stop the second surface 31 of the portable device 3 from proceeding; snap-fit locking as such is firm and therefore may pass a throwing test. The unfastening of the portable device 3 entails lifting the operation plate 321 in the second opening 211 to snap the first and second snap-fit members 25, 320 apart, then pushing the operation plate 321 naturally, such that the whole portable device 3 is moved out of the first opening 210 and uninstalled smoothly.

In conventional technology, an upper casing lid, an indicator, and a server body lock each other, which means that uninstallation/installation of the indicator entails unscrewing/screwing a plurality of screws, thus the unlocking/locking operations are quite complicated. By contrast, with the portable device securing mechanism of the present invention, uninstallation/installation of an indicator may be achieved by taking some simple steps.

The assembly method of the present invention does not involve unscrewing or screwing any screw, thus, compared to conventional technology, the assembly method of the present invention saves users the screwing/unscrewing time.

Unlike conventional technology, the portable device securing mechanism of the present invention does not require drilling plenty of holes in a related device, thus reducing process costs.

The portable device securing mechanism of the present invention may solve various drawbacks of conventional technology and thereby has a great potential for industrial use.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A portable device securing mechanism for securing a portable device in an electronic device, comprising:
a compartment formed in the electronic device and provided with a first opening and a second opening, allowing the portable device to be received in the compartment and have a first surface thereof being exposed through the first opening;
at least one stop member disposed on a bottom surface of the compartment, for pressing against a second surface of the portable device to limit displacement of the portable device toward the second opening, wherein the second surface is opposite to the first surface of the portable device;
a first snap-fit member disposed on the bottom surface of the compartment; and
an elastic element disposed on the second surface of the portable device, and formed with a second snap-fit member for being engaged with the first snap-fit member so as to allow the portable device to be secured in the compartment.

2. The portable device securing mechanism as recited in claim 1, wherein the compartment is a heat dissipating channel above a hard disk compartment of a server.

3. The portable device securing mechanism as recited in claim 2, wherein the first and second openings are an installation opening and a ventilation opening respectively.

4. The portable device securing mechanism as recited in claim 1, wherein the portable device is one selected from the group consisting of a LED indicator, a CD-ROM drive, and a disk drive holding device.

5. The portable device securing mechanism as recited in claim 4, wherein a plurality of LED lamps and USB slots are disposed on the first surface of the LED indicator.

6. The portable device securing mechanism as recited in claim 1, wherein the at least one stop member comprises a plurality of bumps, which are firmly attached, spaced apart and aligned to evenly press against the second surface.

7. The portable device securing mechanism as recited in claim 1, wherein the elastic element is a piece of metal, with one end thereof being connected to the portable device and an opposite end thereof extending toward the second opening.

8. The portable device securing mechanism as recited in claim 1, wherein both the first snap-fit member and the second snap-fit member are corresponding protruding bodies, each having a smooth slope for smooth engagement of the first and second snap-fit members.

9. The portable device securing mechanism as recited in claim 1, further comprising an operation plate integrally connected to the elastic element, wherein the operation plate extends toward the second opening to allow a user to unfasten the portable device from the second opening.

10. The portable device securing mechanism as recited in claim 1, further comprising a plurality of elastic blocks disposed on the portable device, for filling a gap between the portable device and the compartment, so as to fit the portable device in the compartment.
